(19) United States
(12) Patent Application Publication
(10) Pub. No.: US 2026/0195765 A1
(43) Pub. Date: Jul. 9, 2026

(54) SYSTEMS AND METHODS FOR PROVIDING AN ARTIFICIAL INTELLIGENCE DRIVEN SUGGESTION ENGINE WITH UNIVERSAL ENTRY POINTS

(71) Applicant: JPMORGAN CHASE BANK, N.A., New York, NY (US)

(72) Inventors: Azzam NAEEM, New York, NY (US); Kristine W. MA, Cupertino, CA (US)

(21) Appl. No.: 19/012,518

(22) Filed: Jan. 7, 2025

(51) Int. Cl. G06Q 30/015

(52) U.S. Cl. CPC G06Q 30/015

(57) ABSTRACT

Systems and methods for providing an artificial intelligence driven suggestion engine with universal entry points are disclosed. A method may include: providing, via a mobile application interface, a universal entry point for receiving customer queries from a customer; receiving a customer query entered through the universal entry point; interpreting the customer query using a natural language understanding component to generate semantic matches; predicting an intended customer input using an organization-specific vocabulary and an auto-completion module trained from historical customer utterances; generating auto-suggestion results based on the customer query using a natural language understanding model for semantic matches, a lexical match for user interface labels, and a keyword match for business logic; combining the auto-suggestion results and presenting the combined results to the customer with a most relevant result ranked first; and presenting the most relevant result to the customer.

### BACKGROUND OF THE INVENTION

### 1. Field Of The Invention

Embodiments generally relate to systems and methods for providing an artificial intelligence driven suggestion engine with universal entry points.

### 2. Description of the Related Art

Large organizations often provide both customer service representatives and self-service options with mobile applications to customers. For example, a digital assistant may be provided that can receive a question or an issue from a customer, and can identify a solution or provide additional information to the customer. Despite this, customers can—and do—still call customer service representatives.

### SUMMARY OF THE INVENTION

Systems and methods for providing an artificial intelligence driven suggestion engine with universal entry points are disclosed. According to one embodiment, a method may include: providing, via a mobile application interface, a universal entry point for receiving customer queries from a customer; receiving, by an AI-based suggestion engine, a customer query entered through the universal entry point; interpreting, by the AI-based suggestion engine, the customer query using a natural language understanding component to generate semantic matches; predicting, by the AI-based suggestion engine, an intended customer input using an organization-specific vocabulary and an auto-completion module trained from historical customer utterances; generating, by the AI-based suggestion engine, auto-suggestion results based on the customer query using a natural language understanding model for semantic matches, a lexical match for user interface labels, and a keyword match for business logic; combining, by the AI-based suggestion engine, the auto-suggestion results and presenting the combined results to the customer with a most relevant result ranked first; and presenting, by the AI-based suggestion engine, the most relevant result to the customer.

In one embodiment, the method further comprises optimizing, by the AI-based suggestion engine, a latency of generating auto-suggestion results by smart sampling to reduce a search space for the query by identifying sub-topics within a given domain and selecting representative utterances from each sub-topic; and pre-calculating and caching information during system startup to reduce run-time computation.

In one embodiment, the natural language understanding component uses a transformer-based embedding model to generate the semantic matches.

In one embodiment, the organization-specific vocabulary is trained from historical customer utterances to a digital assistant.

In one embodiment, the auto-completion module predicts the intended customer input as the customer types.

In one embodiment, the lexical match for user interface labels is prioritized over the natural language understanding model for semantic matches and the keyword match for business logic.

In one embodiment, the keyword match for business logic associates specific keywords with predefined navigation key results.

In one embodiment, the combined results include both navigational links and conversational links.

In one embodiment, the AI-based suggestion engine uses a context passing mechanism to ensure the customer query is received and understood by a chatbot without requiring the customer to retype the customer query.

In one embodiment, the AI-based suggestion engine normalizes the results from each model track to a range between 0 and 1.

According to another embodiment, a non-transitory computer readable storage medium may include instructions stored thereon, which when read and executed by one or more computer processors, cause the one or more computer processors to perform steps comprising: providing, via a mobile application interface, a universal entry point for receiving customer queries from a customer; receiving a customer query entered through the universal entry point; interpreting the customer query using a natural language understanding component to generate semantic matches; predicting an intended customer input using an organization-specific vocabulary and an auto-completion module trained from historical customer utterances; generating auto-suggestion results based on the customer query using a natural language understanding model for semantic matches, a lexical match for user interface labels, and a keyword match for business logic; combining the auto-suggestion results and presenting the combined results to the customer with a most relevant result ranked first; and presenting the most relevant result to the customer.

In one embodiment, the non-transitory computer readable storage medium may also include instructions stored thereon, which when read and executed by the one or more computer processors, cause the one or more computer processors to perform steps comprising: optimizing a latency of generating auto-suggestion results by: smart sampling to reduce a search space for the customer query by identifying sub-topics within a given domain and selecting representative utterances from each sub-topic; and pre-calculating and caching information during system startup to reduce run-time computation.

In one embodiment, the natural language understanding component uses a transformer-based embedding model to generate the semantic matches.

In one embodiment, the organization-specific vocabulary is trained from historical customer utterances to a digital assistant.

In one embodiment, the auto-completion module predicts the intended customer input as the customer types.

In one embodiment, the lexical match for user interface labels is prioritized over the natural language understanding model for semantic matches and the keyword match for business logic.

In one embodiment, the keyword match for business logic associates specific keywords with predefined navigation key results.

In one embodiment, the combined auto-suggestion results include both navigational links and conversational links.

In one embodiment, the non-transitory computer readable storage medium may also include instructions stored thereon, which when read and executed by the one or more computer processors, cause the one or more computer processors to perform steps comprising: using a context passing mechanism to ensure the customer query is received and understood by a chatbot without requiring the customer to retype the customer query.

In one embodiment, the non-transitory computer readable storage medium may also include instructions stored thereon, which when read and executed by the one or more computer processors, cause the one or more computer processors to perform steps comprising: normalizing the auto-suggestion results to a range between 0 and 1.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for providing an artificial intelligence driven suggestion engine with universal entry points according to an embodiment;

FIG. 2 depicts a method for providing an artificial intelligence driven suggestion engine with universal entry points according to an embodiment;

FIG. 3 depicts a visual representation of the output from this embedding and clustering process according to embodiments; and

FIG. 4 depicts an exemplary computing system for implementing aspects of the present disclosure.

### DETAILED DESCRIPTION OF PREFERRED EMBODIMENTS

Embodiments generally relate to systems and methods for artificial intelligence driven suggestion engine with universal entry points.

According to embodiments, a mobile application may be provided with an entry point that may be used to access an artificial intelligence (AI) based model. The AI model may receive and interpret queries from customers (e.g., typed or transcribed) and may offer suggestions for next steps. For example, in response to a customer typing “lost card,” the AI model may return options (and links) to “lock card” and “replace card,” which are both logical next steps for the query the customer posed.

There may be three tracks on which auto suggestion results may be found. The first track is the natural language understanding model that interprets the customer input at a semantic level and returns intelligent results.

The second track is a lexical match. If the customer types a query which matches a user interface label in the mobile application, the user interface label is returned first. This creates an intuitive experience for the customer where if they had previously used a section of the application (such as “Explore Products”), simply typing a part of that label (like “explore”) returns that result ahead of the other matches.

The third track is a keyword match which is a mechanism that introduces business logic into the process and exercises fine-grained control over the model behavior. For example, the business logic may return options for “reward points” related to travel credit cards in response to the customer typing “travel.” This track allows the keyword “travel” to associate explicitly with rewards and point related results, even if the semantic model misses this connection (due to the stochastic nature of the AI model training process and training data quality).

The results collected from all three tracks may be combined by the model and presented to the user, with the most relevant result ranked first. The results returned by the AI model may be “navigational” (which may redirect the user to another screen in the mobile application), or they may be “conversational” (meaning that the customer enters and uses the digital assistant to complete the task with the help of a chatbot). A seamless context passing mechanism may be used to ensure that the customer's original query is received and understood by the chatbot without having to retype anything.

Embodiments may provide at least some of the following technical advantages. Using the techniques discussed above, the AI model may achieve opposing goals of delivering high accuracy while achieving a very low latency (a requirement from user experience point of view). Embodiments may use auto-completion of partial user utterances, fuzzy match to UI labels, lexical match to a list of business keywords, and a semantic match using a transformer based embedding model to a list of pre-defined user intents. Embodiments may use a combination of smart sampling of the available data, a highly optimized code base, intelligent caching of information during launch, and a set of runtime optimizations.

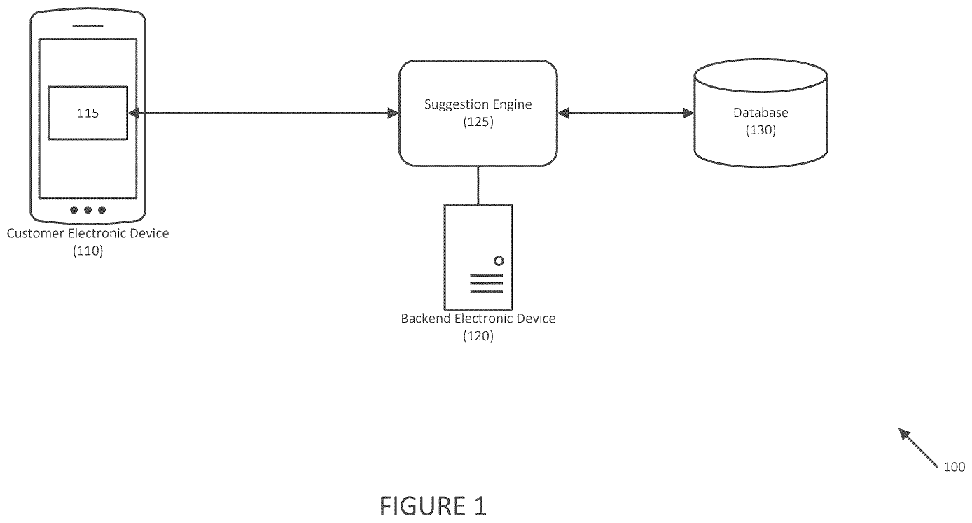

Referring to FIG. 1, a system for providing an artificial intelligence driven suggestion engine with universal entry points is disclosed according to an embodiment. System 100 may include customer electronic device 110, which may be a computer (e.g., workstation, desktop, laptop, notebook, etc.), a smart phone, a smart watch, an Internet of Things (IoT) appliance, etc. Customer electronic device 110 may execute computer program 115, which may be an application, a browser, etc.

Computer program 115 may provide the customer with a search interface, such as a text box.

Computer program 115 may interface with suggestion engine 125 that may be executed by backend electronic device 120 such as a server (e.g., physical and/or cloud-based), a computer, etc. Suggestion engine 125 may interface with one or more databases 130, which may store data regarding the customer's past utterances, organizational rules, etc.

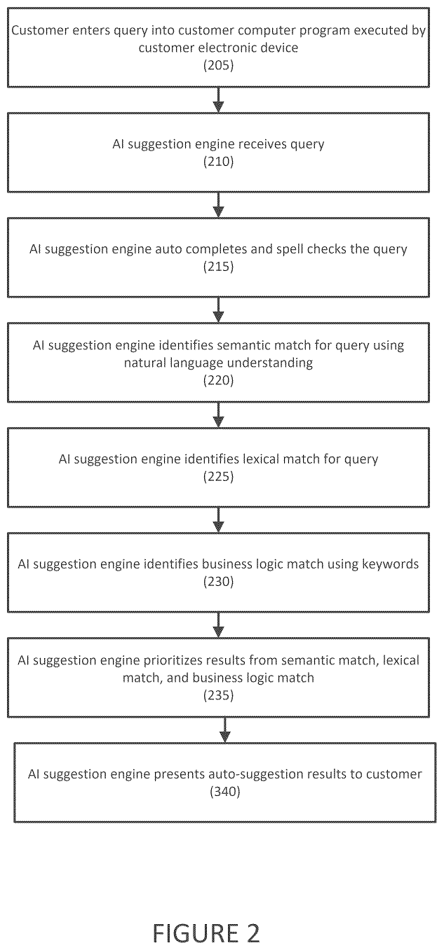

Referring to FIG. 2, a method for providing an artificial intelligence driven suggestion engine with universal entry points is disclosed according to an embodiment.

In step 205, a customer may enter a query into an access point, such as a customer computer program executed by customer electronic device. For example, the customer may enter the query into a text box in a computer application associated with an organization, via a web interface, etc. The text box may provide a universal entry point for receiving customer queries.

In step 210, an AI suggestion engine executed by a backend electronic device for the organization may receive the query, and in step 215, may auto-complete and spell check the query. In one embodiment, an auto-completion module may base its auto-complete suggestion on the complete query on a frequency distribution for the historical utterances from other customers.

It is common for a customer to type partial words into a search bar and wait for initial results to populate before refining the query. To address this, embodiments may include an organization-specific “vocabulary” that may be trained from historical customer utterances to the digital assistant. An auto-completion module may predict what the customer is intending to say within the context of the organization even before the customer completes the input. The auto-completion module may use historic patterns in customer utterances to select the most relevant option within the context of the organization where multiple options exist.

In one embodiment, the auto-completion module may use an organization-specific “vocabulary” that may be trained from historical customer utterances to the digital assistant to identify an auto-complete suggestion. For example, entering “acco” will auto-complete reliably to “account,” and “pi” will auto complete to “PIN” even though similar words are equally possible in this vague context (pit, pig, etc.). The autocomplete module may use historic patterns in customer utterances to select the most relevant option within the context of the organization where multiple options exist.

The auto completion process may be transparent to the user, giving the experience of the model delivering very complete predictions even for partial inputs. The AI model may predict “as the customer types” and therefore even if a particular auto completion is incorrect, the customer can continue typing and the results update immediately, becoming more relevant and accurate with every extra character provided.

In embodiments, the organization-specific vocabulary may also function as a spell checker. For example, “mortage” and “morgage” may both reliably correct to “mortgage,” which is the most organization-specific correction that can be inferred. For another organization in a different field, these terms may correct to a different word, such as “montage.”

In embodiments, the AI-based suggestion engine may optimize the latency of generating auto-suggestion results by using smart sampling to reduce the search space for the AI suggestion engine. This may include identifying sub-topics within a given domain and selecting representative utterances from each sub-topic. It may also pre-calculate and cache information during system startup to reduce run-time computation.

For example, in the “fees” domain, the smart sampler may identify that the customer has usually discussed matters related to overdraft fees, late fees, and foreign transaction fees. The smart sampler then selects one or two utterances from each sub-topic which drastically reduces the search space for the model with minimal information (and therefore predictive performance) loss.

Once the optimized search space is found, the AI suggestion engine may first find the most similar utterances to the current query in the (smart sampled) historic data, and then check which intent has been assigned to the most similar utterances in the training data that are found. Based on these findings, a probability distribution that calculates the likelihood of what the most relevant customer intents are for the provided query may be built.

The intents may then be mapped to customer facing labels, which are a set of business rules. For example, if the AI model predicts customer intent is accountOpenGeneral, then the business rules dictate the model should display auto suggestions for opening a checking, saving, credit card, mortgage, etc. On the other hand, if the customer has typed a more specific utterance like “buy a car,” then the option to open an auto account will be pushed to the top of the list. This is a dynamic reordering based on the specific query the user provided.

With smart sampling, the data represents user utterances. The data may be annotated with one of several intents, such as “feesInquiry”, “cardReplace”, etc. Within each intent, there may be several sub-topics customers often inquire about. For example, within “feesInquiry,” the customer may also ask about credit card fees, transfer fees, international transaction fees, etc. To create a representative sample, the sampling strategy respects not just the intents themselves but also these subtopics within each intent.

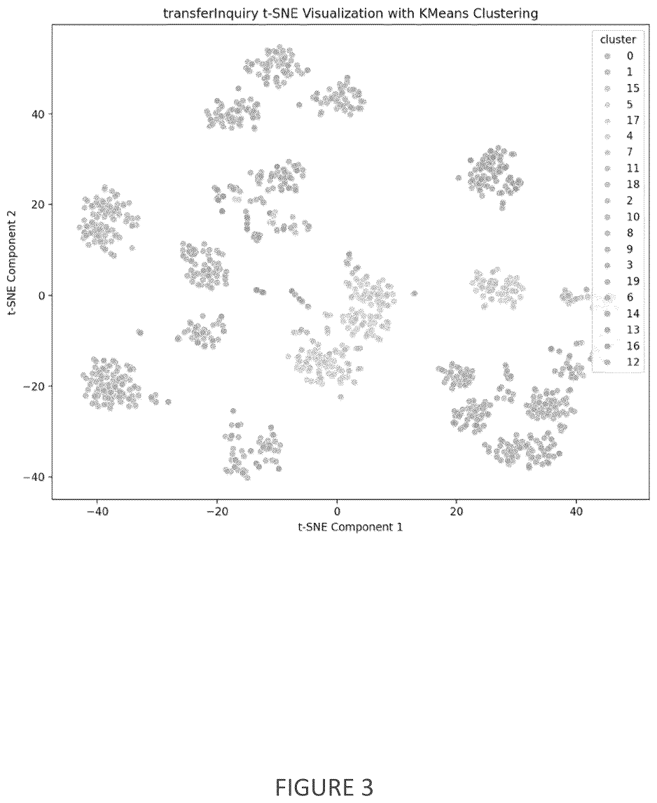

The first step in sampling is to identify the unique subtopics within each intent. This goal is achieved by encoding all the training utterances (for a particular intent) through the fine-tuned embeddings model. The resulting embedding is then clustered using K-Means and may be visualized with the t-Distributed Stochastic Neighborhood Embedding (t-SNE) technique. Once the clusters are found, each cluster represents a sub-topic within that intent. A visual representation of the output from this embedding and clustering process is provided in FIG. 3.

At this point, the number of samples per cluster may be selected. The goal is to ensure that a uniform distribution emerges where for each intent, there is an equal number of utterances across the board (where possible, sometimes the original data has too few data points for a given intent, these are excluded from the balancing process and all available data included).

For intents where enough data is found the logic for selecting the most representative sample while achieving as uniform a distribution as possible is as follows:

Given total number of rows to be sampled N (i.e.: the reduced sample size required), calculate the number of samples required per intent by dividing N by the number of intents in the data.

Let the nᵢ be the number of samples required for intent i. To achieve a balanced sample, the algorithm cycles through each of the subtopics (clusters) identified and samples one utterance from each. This process continues until the required number of samples nᵢ is reached.

Edge case 1 (too few): if any of the sub-topics are exhausted before nᵢ samples are collected, the required number is reached by cycling through remaining sub-topics with data available.

Edge case 2 (too many): if there are more sub-topics for a given intent than the number of samples required from that intent; the algorithm sorts sub-topics from most frequent to least frequent. The least frequent subtopics may be skipped when there are more subtopics than required samples. Favor is given to the right sample size even at the expense of missing a few less common subtopics in the final sample.

Edge case 3: A final edge case is where the intent in total (not sub-topics) do not have enough utterances required of that intent (nᵢ). In this scenario, the short fall is identified and reported. In embodiments, no attempt is made to make up the short fall from other intents, as this may cause more imbalance in the final sample and this is a highly undesirable outcome. The issue with imbalanced intent distribution is that the overly represented intent may overpower less represented intents in the neighbor search process.

The second optimization strategy employed to speed up performance involves pre-calculating and caching as much information as possible during the system startup phase. Thus, multiple lookup tables are created in memory and kept ready, thereby reducing a lot of run-time computation to simple lookups which are very fast.

Another optimization may include converting the AI model to an open-source format. Specifically, the runtime may be optimized for CPU inference which avoids using expensive GPU hardware during production while still achieving a very fast inference time. In addition, the AI model may be quantized to further speed up inference. Quantization refers to the process of storing the model weights at a reduced precision. The process has the effect of decreasing the model size while increasing inference speed.

In step 220, the AI suggestion engine may identify a natural language understanding match for the query. The AI suggestion engine may interpret the customer query using a natural language understanding component to generate semantic matches for the query. The semantic matches may be provided in the user interface.

For example, the AI suggestion engine may tokenize the words in the customer query, and may embed the tokens using, for example, a language representation model, such as distilBERT. Other language representation models may be used as is necessary and/or desired.

Next, a proximity-based machine learning algorithm, such as k-nearest neighbors may be used to identify the closest neighbors for the embeddings to trained embeddings, representing the closest semantic matches for the query.

The closest neighbors may be converted into a probability distribution by counting up how many intents are associated with each of the identified neighbors. The intent taxonomy then may be used to identify which labels to display to the customer as per defined business rules.

In step 225, the AI suggestion engine may identify a lexical match for the query. If the customer types a query which matches a user interface label in the mobile application, the user interface label is returned first. This creates an intuitive experience for the customer where if they had previously used a section of the application (such as “Explore Products”), simply typing a part of that label (like “explore”) returns that result ahead of the other matches.

In embodiments, the AI suggestion engine may compare the words in the query to strings based on unique and common words between them. A match may be based on the number of times a word occurs, an order of the tokens, etc.

The advantage of the string based, or lexical match may be where the user has provided a much shorter input (less than one full word). The semantic match may require more input to deliver an accurate output, the lexical match along with auto-completion addresses this gap.

In step 230, the AI suggestion engine may identify a business match based on keywords.

The third track is a keyword match which is a mechanism that introduces business logic into the process and exercises fine-grained control over the model behavior. For example, the business logic may return options for “reward points” related to travel credit cards in response to the customer typing “travel.” This track allows the keyword “travel” to associate explicitly with rewards and point related results, even if the semantic model misses this connection (due to the stochastic nature of the AI model training process and training data quality).

In one embodiment, if the keyword match has a score that is within a certain distance of a business rule, then the business logic match is used. The business logic may include certain results that are deemed necessary to present together. For instance, if the user has specified that the user's card is lost, business rules require that the option to lock their existing card and order a new replacement card be both presented at once.

In step 235, the AI suggestion engine may process the results for the semantic match, the lexical user interface match, and the business logic match separately. It may normalize the results of each (e.g., to a value of between 0 and 1), and may use a prioritization scheme to prioritize the results.

For example, the first priority is based on the lexical having an exact match. In that case, the lexical match is used.

The next priority is based on the semantic match. If the results from embeddings are within a threshold, then the semantic match is used.

The third priority is based on the semantic match. In one embodiment, the results from the embeddings may be calculated as the normalization of the distances on the embedding space.

In step 230, the AI suggestion engine may present the auto-suggestion results to the customer. The results returned may be “navigational” (which may redirect the user to another screen in the mobile application), or they may be “conversational” (meaning that the customer enters and uses the digital assistant to complete the task with the help of a chatbot). A seamless context passing mechanism may be used to ensure that the customer's original query is received and understood by the chatbot without having to retype anything.

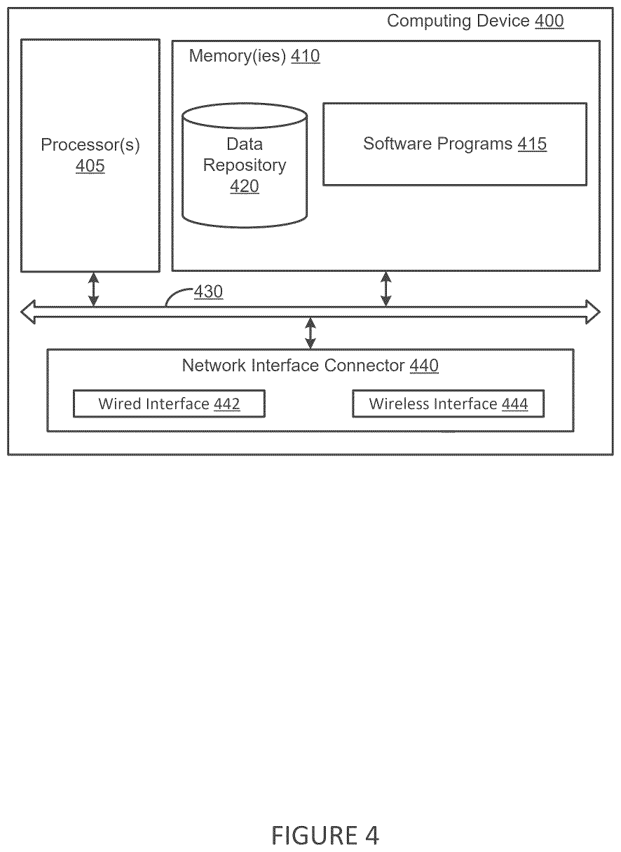

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
providing, via a mobile application interface, a universal entry point for receiving customer queries from a customer;
receiving, by an AI-based suggestion engine, a customer query entered through the universal entry point;
interpreting, by the AI-based suggestion engine, the customer query using a natural language understanding component to generate semantic matches;
predicting, by the AI-based suggestion engine, an intended customer input using an organization-specific vocabulary and an auto-completion module trained from historical customer utterances;
generating, by the AI-based suggestion engine, auto-suggestion results based on the customer query using a natural language understanding model for semantic matches, a lexical match for user interface labels, and a keyword match for business logic;
combining, by the AI-based suggestion engine, the auto-suggestion results and presenting the combined results to the customer with a most relevant result ranked first; and
presenting, by the AI-based suggestion engine, the most relevant result to the customer.

2. The method of claim 1, further comprising:
optimizing, by the AI-based suggestion engine, a latency of generating auto-suggestion results by:
smart sampling to reduce a search space for the customer query by identifying sub-topics within a given domain and selecting representative utterances from each sub-topic; and
pre-calculating and caching information during system startup to reduce run-time computation.

3. The method of claim 1, wherein the natural language understanding component uses a transformer-based embedding model to generate the semantic matches.

4. The method of claim 1, wherein the organization-specific vocabulary is trained from historical customer utterances to a digital assistant.

5. The method of claim 1, wherein the auto-completion module predicts the intended customer input as the customer types.

6. The method of claim 1, wherein the lexical match for user interface labels is prioritized over the natural language understanding model for semantic matches and the keyword match for business logic.

7. The method of claim 1, wherein the keyword match for business logic associates specific keywords with predefined navigation key results.

8. The method of claim 1, wherein the combined auto-suggestion results include both navigational links and conversational links.

9. The method of claim 1, wherein the AI-based suggestion engine uses a context passing mechanism to ensure the customer query is received and understood by a chatbot without requiring the customer to retype the customer query.

10. The method of claim 1, wherein the AI-based suggestion engine normalizes the auto-suggestion results to a range between 0 and 1.

11. A non-transitory computer readable storage medium, including instructions stored thereon, which when read and executed by one or more computer processors, cause the one or more computer processors to perform steps comprising:
providing, via a mobile application interface, a universal entry point for receiving customer queries from a customer;
receiving a customer query entered through the universal entry point;
interpreting the customer query using a natural language understanding component to generate semantic matches;
predicting an intended customer input using an organization-specific vocabulary and an auto-completion module trained from historical customer utterances;
generating auto-suggestion results based on the customer query using a natural language understanding model for semantic matches, a lexical match for user interface labels, and a keyword match for business logic;
combining the auto-suggestion results and presenting the combined results to the customer with a most relevant result ranked first; and
presenting the most relevant result to the customer.

12. The non-transitory computer readable storage medium of claim 11, further including instructions stored thereon, which when read and executed by the one or more computer processors, cause the one or more computer processors to perform steps comprising:
optimizing a latency of generating auto-suggestion results by:
smart sampling to reduce a search space for the customer query by identifying sub-topics within a given domain and selecting representative utterances from each sub-topic; and
pre-calculating and caching information during system startup to reduce run-time computation.

13. The non-transitory computer readable storage medium of claim 11, wherein the natural language understanding component uses a transformer-based embedding model to generate the semantic matches.

14. The non-transitory computer readable storage medium of claim 11, wherein the organization-specific vocabulary is trained from historical customer utterances to a digital assistant.

15. The non-transitory computer readable storage medium of claim 11, wherein the auto-completion module predicts the intended customer input as the customer types.

16. The non-transitory computer readable storage medium of claim 11, wherein the lexical match for user interface labels is prioritized over the natural language understanding model for semantic matches and the keyword match for business logic.

17. The non-transitory computer readable storage medium of claim 11, wherein the keyword match for business logic associates specific keywords with predefined navigation key results.

18. The non-transitory computer readable storage medium of claim 11, wherein the combined auto-suggestion results include both navigational links and conversational links.

19. The non-transitory computer readable storage medium of claim 11, further including instructions stored thereon, which when read and executed by the one or more computer processors, cause the one or more computer processors to perform steps comprising:
using a context passing mechanism to ensure the customer query is received and understood by a chatbot without requiring the customer to retype the customer query.

20. The non-transitory computer readable storage medium of claim 11, further including instructions stored thereon, which when read and executed by the one or more computer processors, cause the one or more computer processors to perform steps comprising:
normalizing the auto-suggestion results to a range between 0 and 1.
